(19) United States
(12) Patent Application Publication
(10) Pub. No.: US 2026/0176862 A1
(43) Pub. Date: Jun. 25, 2026

(54) COLUMN FIXING METAL MEMBER, METHOD FOR MANUFACTURING COLUMN FIXING METAL MEMBER, AND BUILDING

(71) Applicant: Sekisui House, Ltd., Osaka-Shi, Osaka (JP)

(72) Inventors: Daiki Fukumoto, Osaka-shi (JP); Kazumi Hijikata, Osaka-shi (JP); Keisuke Yanagisawa, Osaka-shi (JP); Takaaki Imamura, Osaka-shi (JP)

(73) Assignee: Sekisui House, Ltd., Osaka-Shi, Osaka (JP)

(21) Appl. No.: 18/715,273

(22) PCT Filed: Aug. 4, 2023
(86) PCT No.: PCT/JP2023/028630

§ 371 Date: May 31, 2024

(30) Foreign Application Priority Data
Apr. 27, 2023 (JP) 2023-073525

(51) Int. Cl. E04B 1/38; B23K 31/02

(52) U.S. Cl. CPC E04B 1/388; B23K 31/02; E04B 2001/389

(57) ABSTRACT

A column fixing metal member includes a first plate configured to be fixed to a foundation portion, a support portion provided on the first plate a second plate provided on an upper portion of the support portion, and a coupling portion extending from the second plate and configured to be coupled to a column. The support portion includes a first end surface, a side surface that intersects the first end surface, and a first boundary line that is a boundary between the first end surface and the side surface. The first boundary line includes a first boundary region. The second plate has a cutout portion including a cutout edge. The cutout edge has a first cutout region. The first cutout region extends along the first boundary region, in plan view. A portion of the support portion including the first boundary region is fixed to the first plate by welding.

### TECHNICAL FIELD

The present disclosure relates to a column fixing metal member, a method for manufacturing a column fixing metal member, and a building.

### BACKGROUND ART

In a building, a column fixing metal member that fixes a column to a foundation is known (for example, Patent Literature 1). In an example disclosed in Patent Literature 1, the column fixing metal member (a fixing metal bracket in Patent Literature 1) includes a first plate (a base plate in Patent Literature 1), a second plate (a support plate in Patent Literature 1), and a support portion (an upright plate in Patent Literature 1). The support portion is welded to the first plate and the second plate such that the first plate and the second plate are parallel to each other.

### CITATION LIST

### Patent Literature

Patent Literature 1: Japanese Laid-Open Patent Publication No. 2002-115339

### SUMMARY OF INVENTION

### Technical Problem

The support portion is welded so as to be sandwiched between the first plate and the second plate. In the case of such a structure, it is difficult to apply a welding rod to a portion to be welded in the support portion and the plates, and thus welding may not be performed smoothly. When the welding cannot be smoothly performed, the welding may not be appropriately performed and the strength of the column fixing metal member may be reduced. There is room for improvement in a column fixing metal member, a method for manufacturing a column fixing metal member, and a building from the viewpoint of the strength of the column fixing metal member.

### Solution to Problem

(1) To achieve the foregoing objective, a column fixing metal member configured to fix a column to a foundation portion. The column fixing metal member includes a first plate fixed to the foundation portion, a support portion provided on the first plate, a second plate provided on an upper portion of the support portion, and a coupling portion extending upward from the second plate and coupled to the column. The support portion includes a first end surface in contact with an upper surface of the first plate, a side surface intersecting the first end surface, and a first boundary line that is a boundary between the first end surface and the side surface. The first boundary line includes a first boundary region. The second plate includes a cutout portion including a cutout edge. The cutout edge of the cutout portion includes a first cutout region. The first cutout region of the cutout portion extends along the first boundary region of the support portion, in plan view. A portion of the support portion including the first boundary region is fixed to the first plate by welding.

According to this configuration, when the portion of the support portion including a first boundary region is welded to the first plate, the portion including the first boundary region is smoothly welded to the first plate by aligning a welding rod of a welding tool along the first cutout region. As described above, the column fixing metal member has a structure that can be smoothly welded, and thus the number of column fixing metal members each having a low strength at the welded portion is reduced. In this way, it is possible to provide a column fixing metal member having a high strength.
(2) In the column fixing metal member of the above item (1), the cutout edge of the cutout portion extends along the first boundary line of the support portion, in plan view. According to this configuration, the support portion and the upper surface of the first plate are smoothly welded to each other by aligning the welding rod of the welding tool along the cutout edge. Thus, it is possible to provide a column fixing metal member having a high strength.
(3) In the column fixing metal member of the above item (1), the support portion includes a first support member and a second support member. The first support member and the second support member include corner portions, respectively. The first support member and the second support member are disposed on the first plate such that a convex portion at the corner portion of the first support member faces a convex portion at the corner portion of the second support member. According to this configuration, the second plate can be supported by the first support member and the second support member.
(4) In the column fixing metal member of the above item (3), the cutout portion includes a cutout corner portion, and a bisector of the corner portion of the first support member extends in a same direction as a bisector of the cutout corner portion of the cutout portion, in plan view. According to this configuration, a tip of the welding rod of the welding tool can be readily aligned with the corner portion of the support portion by aligning the welding rod of the welding tool along the cutout corner portion. As a result, the corner portion is appropriately welded to the first plate. Thus, a bonding strength between the support portion and the first plate is improved.
(5) In the column fixing metal member of the above item (4), the first boundary line includes a first arc portion forming the corner portion. The cutout portion includes a second cutout region having an arc shape forming the cutout corner portion. The first arc portion either extends along a concentric circle concentric with a second circle including the second cutout region, in plan view, or is an arc having a radius smaller than a radius of the second circle including the second cutout region. According to this configuration, the tip of the welding rod of the welding tool can be readily aligned with the first arc portion of the support portion by aligning the welding rod of the welding tool along the second cutout region. As a result, the portion of the support portion including the first arc portion is appropriately welded to the first plate. Thus, a bonding strength between the support portion and the first plate is improved.
(6) In the column fixing metal member of the above item (1), an outer periphery of the second plate is located inside an outer periphery of the first plate in plan view. According to this configuration, it is easy to check the state of the first plate in a state in which the column fixing metal member is placed on the foundation portion.
(7) To achieve the foregoing objective, a building includes a foundation portion, a column, and the column fixing metal member of any one of the above items (1) to (6). The first plate of the column fixing metal member is fixed to the foundation portion. The column is coupled to the coupling portion of the column fixing metal member. According to this configuration, in the building, the coupling strength of the column with respect to the foundation portion is improved, and thus earthquake resistance of the building is improved.
(8) In the building of the above item (7), an outer periphery of the column is located outside the second plate of the column fixing metal member in plan view. When the outer periphery of the column is located inside the second plate, water condensed on the column may be accumulated in the second plate. In this respect, according to the above configuration, the condensed water readily drips downward from the lower end of the column without being hindered by the second plate. As a result, accumulation of water in the second plate is suppressed, and thus aged deterioration of the column due to water is suppressed.
(9) To achieve the foregoing objective, a method for manufacturing a column fixing metal member is provided. The column fixing metal member includes a first plate, a support portion, a second plate, and a coupling portion coupled to a column. The method includes a temporarily fixing step of temporarily fixing the second plate and the support portion to each other, a first welding step of welding the support portion and the first plate to each other in a state in which the support portion is temporarily fixed to the second plate, a second welding step of welding the second plate and the support portion to each other, and a third welding step of welding the coupling portion to the second plate. The support portion includes a first end surface in contact with an upper surface of the first plate, a side surface intersecting the first end surface, and a first boundary line that is a boundary between the first end surface and the side surface. The first boundary line includes a first boundary region. The second plate includes a cutout portion including a cutout edge. The cutout edge of the second plate includes a first cutout region. In the temporary fixing step, the second plate is temporarily fixed to the support portion in a state in which the second plate is disposed on the support portion such that the first cutout region of the cutout portion extends along the first boundary region of the first boundary line. In the first welding step, a portion of the support portion including the first boundary region is welded to the first plate such that a welding rod of a welding tool is aligned along the first cutout region. According to this configuration, welding is performed while the welding rod of the welding tool is aligned along the first cutout region, and thus the portion including the first boundary region and the first plate are appropriately welded to each other.
(10) To achieve the forgoing objective, a method for manufacturing a column fixing metal member is provided. The column fixing metal member includes a first plate, a support portion, a second plate, and a coupling portion coupled to a column. The method includes a first welding step of welding the support portion to the second plate, a second welding step of welding the first plate to the support portion, and a third welding step of welding the coupling portion to the second plate. The support portion includes a first end surface in contact with an upper surface of the first plate, a side surface intersecting the first end surface, and a first boundary line that is a boundary between the first end surface and the side surface. The first boundary line includes a first boundary region. The second plate includes a cutout portion including a cutout edge. The cutout edge of the second plate includes a first cutout region. In the first welding step, the second plate is welded to the support portion in a state in which the second plate is disposed on the support portion such that the first cutout region of the cutout portion extends along the first boundary region of the first boundary line. In the second welding step, a portion of the support portion including the first boundary region is welded to the first plate such that a welding rod of a welding tool is aligned along the first cutout region. According to this configuration, the support portion is welded to the first plate in a state in which the first cutout region extends along the first boundary region in plan view. At this time, the portion including the first boundary region is welded to the first plate such that the welding rod of the welding tool is aligned along the first cutout region. Thus, the portion including the first boundary region and the first plate are appropriately welded to each other.

### Advantageous Effects of Invention

According to the column fixing metal member and the method for manufacturing a column fixing metal member of the present disclosure, it is possible to provide a column fixing metal member having a high strength. According to the building, earthquake resistance of the building is improved.

### BRIEF DESCRIPTION OF DRAWINGS

FIG. 1 is a schematic diagram of a building.

FIG. 2 is a perspective view of a column fixing metal member according to a first embodiment.

FIG. 3 is a cross-sectional view of the column fixing metal member taken along line 3-3 in FIG. 2.

FIG. 4 is a cross-sectional view of the column fixing metal member taken along line 4-4 in FIG. 2.

FIG. 5 is a front view of the column fixing metal member.

FIG. 6 is a plan view of the column fixing metal member.

FIG. 7 is an exploded perspective view of a section including the column fixing metal member in the building.

FIG. 8 is a plan view of the column fixing metal member illustrating one process of a first welding step of a method for manufacturing a column fixing metal member.

FIG. 9 is a cross-sectional view of the column fixing metal member taken along line 9-9 in FIG. 8.

FIG. 10 is a plan view illustrating another process of the first welding step of the method for manufacturing a column fixing metal member.

FIG. 11 is a cross-sectional view of the column fixing metal member taken along line 11-11 in FIG. 10.

FIG. 12 is a perspective view of the column fixing metal member according to a third embodiment.

FIG. 13 is a front view of the column fixing metal member according to the third embodiment.

FIG. 14 is a perspective view of the column fixing metal member according to a fourth embodiment.

FIG. 15 is a front view of the column fixing metal member according to the fourth embodiment.

FIG. 16 is a perspective view of the column fixing metal member according to a fifth embodiment.

FIG. 17 is a perspective view of the column fixing metal member according to a modification (1).

### DESCRIPTION OF EMBODIMENTS

### First Embodiment

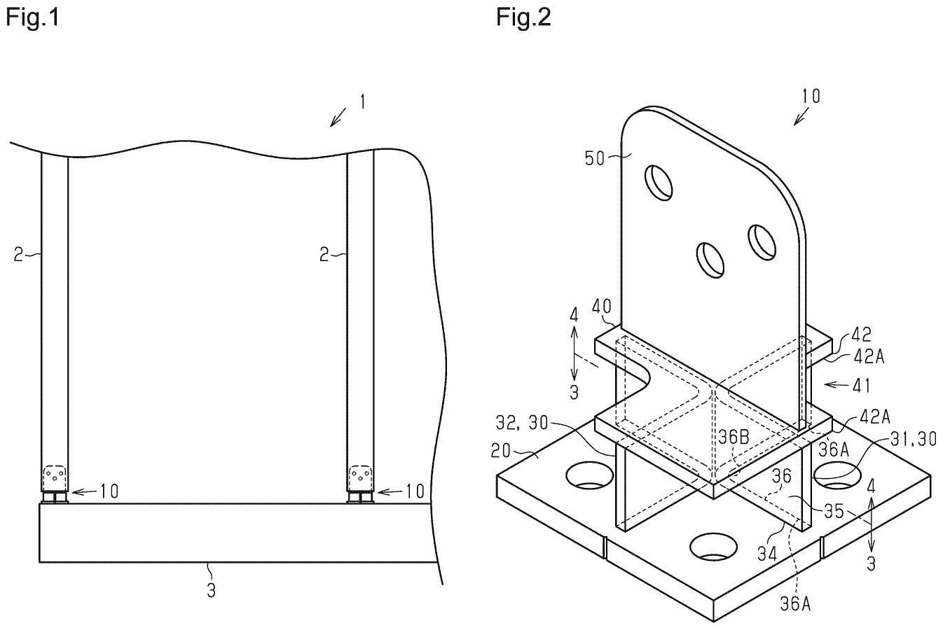

A building 1 and a column fixing metal member 10 that fixes a column 2 to a foundation portion 3 will be described with reference to FIGS. 1 to 11.

As illustrated in FIG. 1, the column fixing metal member 10 fixes the column 2 of the building 1 to the foundation portion 3. Examples of the building 1 include a detached house, an apartment building, and a public facility. The building 1 according to a first embodiment is the detached house.

### Column Fixing Metal Member

As illustrated in FIG. 2, the column fixing metal member 10 includes a first plate 20 fixed to the foundation portion 3 (see FIG. 1), a support portion 30 provided on the first plate 20, and a second plate 40 provided on an upper portion of the support portion 30. Further, the column fixing metal member 10 includes a coupling portion 50 that extends upward from the second plate 40 and is coupled to the column 2 (see FIG. 1).

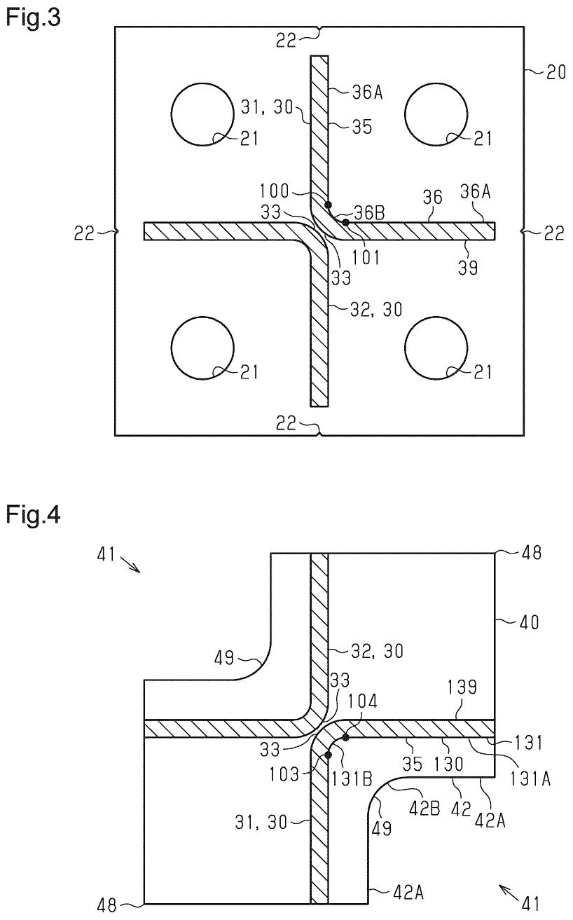

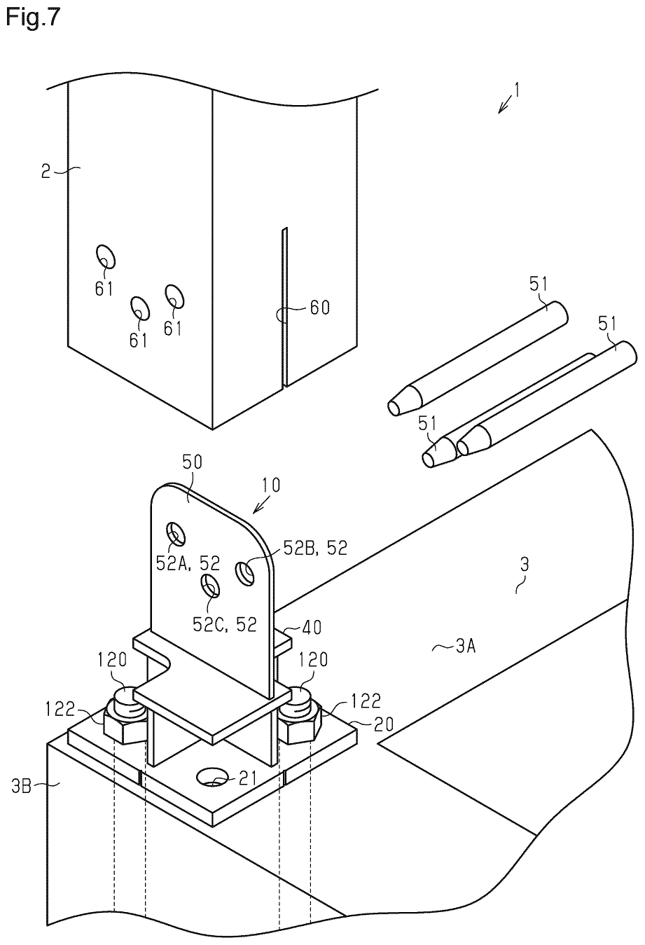

As illustrated in FIG. 3, the first plate 20 is formed in a square shape in plan view. Insertion holes 21 through which anchor bolts 120 (see FIG. 7) are inserted are provided at four corners of the first plate 20, respectively. An outer diameter of the insertion hole 21 is formed to be slightly larger than an outer diameter of the anchor bolt 120. A positioning portion 22 is provided at each of outer edges of the first plate 20. The positioning portion 22 is provided at a central portion of each side of the first plate 20 in plan view of the first plate 20. An end portion of the support portion 30 (described later) is located near the positioning portion 22. The positioning portion 22 indicates a position of the end portion of the support portion 30 with respect to the first plate 20. The positioning portion 22 is used as a mark for positioning the support portion 30 when the support portion 30 is welded to the first plate 20 in the manufacture of the column fixing metal member 10.

The support portion 30 includes a first support member 31 and a second support member 32. The first support member 31 and the second support member 32 are provided on the first plate 20 so as to protrude from an upper surface of first plate 20. In the present embodiment, the first support member 31 and the second support member 32 are configured to include corner portions 33, respectively. In one example, the first support member 31 and the second support member 32 are formed by bending a metal plate. The first support member 31 includes the corner portion 33 formed by bending a metal plate. The second support member 32 includes the corner portion 33 formed by bending a metal plate. The corner portion 33 of the first support member 31 forms 90 degrees in plan view. The corner portion 33 of the second support member 32 forms 90 degrees in plan view. The first support member 31 and the second support member 32 are disposed on the first plate 20 such that a convex portion at the corner portion 33 of the first support member 31 faces a convex portion at the corner portion 33 of the second support member 32. An end portion of the first support member 31 is disposed near the positioning portion 22 of the first plate 20. An end portion of the second support member 32 is disposed near the positioning portion 22 of the first plate 20.

As illustrated in FIGS. 2 and 3, the support portion 30 includes a first end surface 34 in contact with the upper surface of the first plate 20, a side surface 35 intersecting the first end surface 34, and a first boundary line 36 that is a boundary between the first end surface 34 and the side surface 35. The support portion 30 further includes a third boundary line 39 that is a boundary between the first end surface 34 and the side surface 35 and is a portion different from the first boundary line 36. In the present embodiment, each of the first support member 31 and the second support member 32 includes the first end surface 34, the side surface 35, the first boundary line 36, and the third boundary line 39. The side surface 35 includes a surface including a concave curved surface and a surface opposite to the concave curved surface and including a convex curved surface. The first boundary line 36 is a boundary between the surface including the concave curved surface in the side surface 35 and the first end surface 34. The third boundary line 39 is a boundary between the surface including the convex curved surface in the side surface 35 and the first end surface 34.

The first boundary line 36 includes a first boundary region 36A. Multple first boundary regions 36A may be provided. In one example, the first boundary line 36 includes two first boundary regions 36A having a linear shape. Extension lines of the two first boundary regions 36A, respectively, are orthogonal to each other. A portion of the support portion 30 including the first boundary region 36A is fixed to the first plate 20 by welding.

The first boundary line 36 includes a first arc portion 36B forming the corner portion 33. The first arc portion 36B is configured to be an arc or a curve similar to an arc in plan view. In the present embodiment, the first arc portion 36B is configured to be the arc in plan view.

The first arc portion 36B connects the two first boundary regions 36A to each other in plan view. The first arc portion 36B is connected to one first boundary region 36A at a first arc point 100 that is one end of the first arc portion 36B. The first arc portion 36B is connected to the other first boundary region 36A at a second arc point 101 that is the other end of the first arc portion 36B.

As illustrated in FIG. 4, the support portion 30 includes a second end surface 130 in contact with a lower surface of the second plate 40, and a second boundary line 131 that is a boundary between the second end surface 130 and the side surface 35. The second boundary line 131 includes a second boundary region 131A. The support portion 30 further includes a fourth boundary line 139 that is a boundary between the second end surface 130 and the side surface 35 and is a portion different from the second boundary line 131. In the present embodiment, each of the first support member 31 and the second support member 32 includes the second end surface 130, the second boundary line 131, and the fourth boundary line 139. The second boundary line 131 is a boundary between a surface including a concave curved surface in the side surface 35 and the second end surface 130. The fourth boundary line 139 is a boundary between the surface including the convex curved surface in the side surface 35 and the second end surface 130.

The second boundary line 131 includes a second boundary region 131A. Multiple second boundary regions 131A may be provided. In one example, the second boundary line 131 includes two second boundary regions 131A having a linear shape. Extension lines of the two second boundary regions 131A, respectively, are orthogonal to each other. A portion of the support portion 30 including the second boundary region 131A is fixed to the second plate 40 by welding. The second boundary line 131 includes a second arc portion 131B forming the corner portion 33. The second arc portion 131B is configured to be an arc or a curve similar to an arc in plan view. In the present embodiment, the second arc portion 131B is configured to be the arc in plan view. The second arc portion 131B connects the two second boundary regions 131A to each other in plan view. The second arc portion 131B is connected to one second boundary region 131A at a third arc point 103 that is one end of the second arc portion 131B. The second arc portion 131B is connected to the other second boundary region 131A at a fourth arc point 104 that is the other end of the second arc portion 131B. The third arc point 103 is located at a position overlapping the first arc point 100 in plan view. The fourth arc point 104 is located at a position overlapping the second arc point 101 in plan view.

As illustrated in FIGS. 3 and 4, the second plate 40 is provided at a position opposite to the first plate 20 with respect to the support portion 30. That is, the support portion 30 is disposed between the first plate 20 and the second plate 40. The second plate 40 includes a cutout portion 41 including a cutout edge 42. The cutout portion 41 includes a cutout corner portion 49. The cutout corner portion 49 of the cutout portion 41 forms 90 degrees in plan view. The angle of the cutout corner portion 49 is defined as an angle formed by extension lines of two first cutout regions 42A, respectively, (see below) in plan view.

In the present embodiment, the second plate 40 includes two cutout portions 41. The second plate 40 includes two projected corner portions 48. The two cutout portions 41 are configured to be symmetrical to each other with respect to a line connecting the two projected corner portions 48 to each other. Each of the two cutout portions 41 is cut out so as to expose one insertion hole 21 in plan view. For example, in the present embodiment, the two cutout portions 41 expose two insertion holes 21, respectively, provided at corners in a diagonal relationship among the four corners of the first plate 20 in plan view (see FIG. 6).

The cutout edge 42 includes first cutout regions 42A. The first cutout regions 42A extend linearly. In the present embodiment, the cutout edge 42 includes the two first cutout regions 42A. Further, the cutout edge 42 includes a second cutout region 42B forming the cutout corner portion 49 (see FIG. 6). That is, the cutout edge 42 includes the two first cutout regions 42A and the second cutout region 42B that connects the two first cutout regions 42A to each other. Extension lines of the two first cutout regions 42A, respectively, are orthogonal to each other. The second cutout region 42B is configured to have an arc shape in plan view.

The cutout edge 42 is configured as follows in relation to the first boundary region 36A.

Each of the two first cutout regions 42A is configured to extend along the first boundary region 36A of the support portion 30. Specifically, an angle formed between the extension line of the first cutout region 42A and the extension line of the first boundary region 36A of the first boundary line 36 is in a range of 0 degrees to 5 degrees in plan view. Preferably, the first cutout region 42A is parallel to the first boundary region 36A of the first boundary line 36 in plan view (see FIG. 6).

The cutout edge 42 of the cutout portion 41 may be configured to extend along the first boundary line 36 of the support portion 30, as a whole, in plan view. Specifically, each of the two first cutout regions 42A is configured to extend along the first boundary region 36A of the support portion 30, and the second cutout region 42B is configured to extend along the first arc portion 36B of the support portion 30.

Further, a bisector 106 of the corner portion 33 of the first support member 31 may be configured to extend in the same direction as a bisector 107 of the cutout corner portion 49 of the cutout portion 41 in plan view (see FIG. 6). Similarly, the bisector 106 of the corner portion 33 of the second support member 32 may be configured to extend in the same direction as the bisector 107 of the cutout corner portion 49 of the other cutout portion 41 in plan view (see FIG. 6).

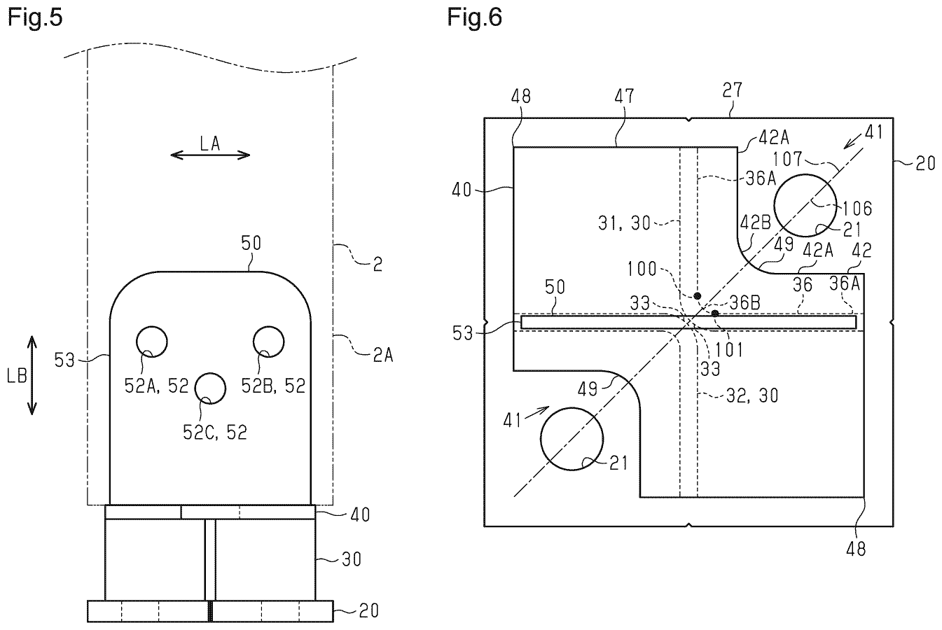

As illustrated in FIG. 5, the coupling portion 50 is provided on the second plate 40 so as to protrude from an upper surface of the second plate 40. The coupling portion 50 is provided at a position opposite to the support portion 30 with respect to the second plate 40. The coupling portion 50 is disposed to extend along a straight line passing through the two positioning portions 22 located at positions, respectively, opposite to each other in the first plate 20 in plan view. The coupling portion 50 is made of a metal plate. The coupling portion 50 is provided with mulitiple coupling holes 52 for passing drift pins 51, respectively, (see FIG. 7) for coupling the column 2 and the coupling portion 50 to each other. In the present embodiment, a first coupling hole 52A, a second coupling hole 52B, and a third coupling hole 52C are provided in the coupling portion 50. The coupling portion 50 includes a coupling end surface 53 that is a surface intersecting a main surface of the coupling portion 50 and extends in a longitudinal direction LB. A lateral width of the coupling portion 50 along a lateral direction LA is equal to or smaller than a lateral width of the column 2.

In a front view of the coupling portion 50, the coupling holes 52 are provided at predetermined positions, respectively, of the coupling portion 50. The coupling holes 52 are provided at predetermined intervals in the coupling portion 50. In the present embodiment, three coupling holes 52 are provided in the coupling portion 50. In order to provide the three coupling holes 52 at the predetermined intervals in the coupling portion 50, two coupling holes 52 among the three coupling holes 52 are disposed at a predetermined interval in the lateral direction LA. The remaining one coupling hole 52 is disposed at a position deviated from the two coupling holes 52 with respect to the lateral direction LA and the longitudinal direction LB. Two coupling holes 52, adjacent to each other in an oblique direction (hereinafter, “oblique direction”) obliquely intersecting the longitudinal direction LB, are provided at a predetermined interval. In the present embodiment, the first coupling hole 52A and the second coupling hole 52B are adjacent to each other in the lateral direction LA and provided at a predetermined interval. The third coupling hole 52C is provided at a position away from the first coupling hole 52A and the second coupling hole 52B in the oblique direction.

In one example, for the first coupling hole 52A and the second coupling hole 52B adjacent to each other in the lateral direction LA, the distance from a center of the first coupling hole 52A to a center of the second coupling hole 52B is 45 mm or more. For the first coupling hole 52A and the third coupling hole 52C adjacent to each other in the oblique direction, the distance from a center of the third coupling hole 52C to the center of the first coupling hole 52A is 25 mm or more. For the second coupling hole 52B and the third coupling hole 52C adjacent to each other in the oblique direction, the distance from the center of the third coupling hole 52C to the center of the second coupling hole 52B is 25 mm or more.

With such an arrangement of the three coupling holes 52, the distances between the coupling holes 52 are ensured, and thus the strength of the coupling portion 50 is ensured.

Thus, the size of the coupling portion 50 is reduced. Specifically, the area of the coupling portion 50 in a front view is reduced. With such a structure, the column fixing metal member 10 can include the coupling portion 50 having a narrow width corresponding to the column 2 having a smaller cross-sectional area than the conventional one. Even when the column fixing metal member 10 includes the coupling portion 50 having the narrow width, the strength of the coupling portion 50 is ensured, and thus the column fixing metal member 10 can be coupled to the column 2 having the smaller cross-sectional area with appropriate strength.

Among the multiple coupling holes 52, the coupling hole 52 closest to the coupling end surface 53 in the lateral direction LA is provided in the coupling portion 50 so as to be at a predetermined interval from the coupling end surface 53. For example, in the present embodiment, the center of the first coupling hole 52A is located at a position spaced apart by an interval of 15 mm or more from the coupling end surface 53 in the lateral direction LA.

As illustrated in FIG. 6, an outer periphery 47 of the second plate 40 is located inside an outer periphery 27 of the first plate 20 in plan view. The coupling end surface 53 of the coupling portion 50 is located inside the outer periphery 47 of the second plate 40.

### Procedure for Fixing Column to Foundation Portion

A procedure for fixing the column 2 to the foundation portion 3 by the column fixing metal member 10 will be described with reference to FIG. 7. The column 2 is made of wood. The column 2 includes a slit 60 into which the coupling portion 50 is inserted and multiple pin insertion holes 61 through which the drift pins 51 are inserted, respectively. The pin insertion hole 61 forms a through-hole through which the drift pin 51 is inserted by overlapping the coupling hole 52 when the coupling portion 50 is inserted into the slit 60. An outer diameter of the through-hole is configured to be slightly larger than an outer diameter of the drift pin 51.

First, as illustrated in FIG. 7, the anchor bolt 120 installed in the foundation portion 3 is inserted into the insertion hole 21 of the first plate 20. Next, the column fixing metal member 10 is fastened to the foundation portion 3 by engaging a nut 122 with the anchor bolt 120. Then, the column 2 is disposed on the column fixing metal member 10 so as to insert the coupling portion 50 into the slit 60 of the column 2. The drift pin 51 is inserted into each of the through-holes formed by the coupling holes 52 and the pin insertion holes 61. As a result, the column 2 is coupled to the column fixing metal member 10. At this time, a gap is provided between a lower surface of the column 2 and the second plate 40 of the column fixing metal member 10. When the gap is present, air permeability between the lower surface of the column 2 and the second plate 40 of the column fixing metal member 10 is improved. Thus, deterioration of the lower surface of the column 2 is suppressed.

### Method for Manufacturing Column Fixing Metal member

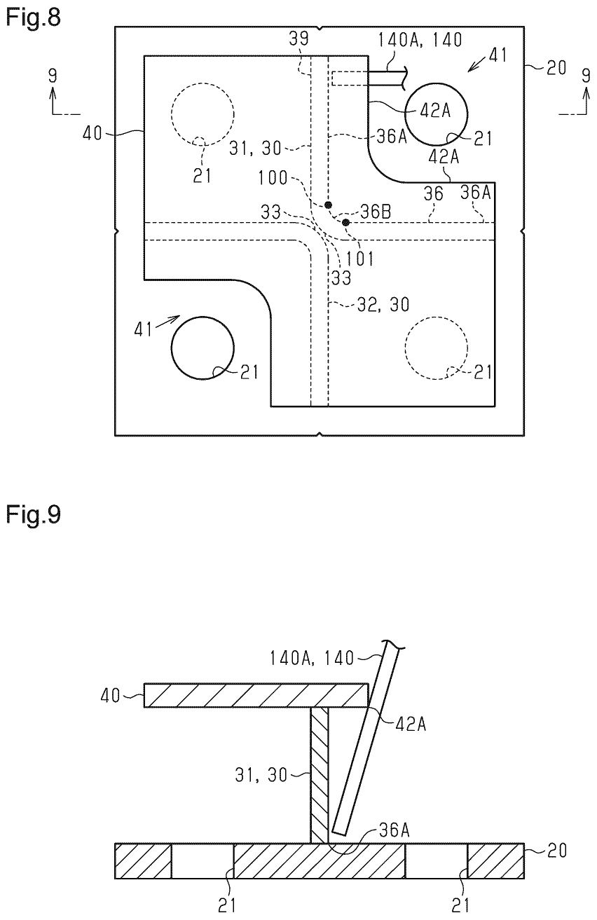

A method for manufacturing the column fixing metal member 10 according to the present embodiment will be described with reference to FIGS. 8 to 11. In the method for manufacturing the column fixing metal member 10, the support portion 30 is temporarily fixed to the second plate 40 before the first plate 20 and the second plate 40 are welded to the support portion 30. Examples of a method of welding and temporary welding include arc welding, plasma arc welding, and gas welding. A welding tool 140 is an apparatus that welds a target member. As one example, the welding tool 140 is the apparatus that welds the target member by arc welding. In the present embodiment, the welding tool 140 includes a welding rod 140A.

The method for manufacturing the column fixing metal member 10 includes a temporary fixing step, a first welding step, a second welding step, and a third welding step. Each step will be described below. FIGS. 8 to 11 are views referred to when describing the method for welding the support portion 30 to the first plate 20.

In the temporary fixing step, the second plate 40 and the support portion 30 are temporarily fixed to each other. The second plate 40 is temporarily fixed to the support portion 30 in a state in which the second plate 40 is disposed on the support portion 30 such that the first cutout region 42A of the cutout portion 41 extends along the first boundary region 36A of the first boundary line 36. In the present embodiment, the cutout portion 41 includes the two first cutout regions 42A. The first support member 31 includes the two first boundary regions 36A. In the present embodiment, the support portion 30 is temporarily fixed to the second plate 40 such that one first boundary region 36A is parallel to one first cutout region 42A and the other first boundary region 36A is parallel to the other first cutout region 42A. In addition, the first support member 31 is temporarily fixed such that the bisector 106 of the corner portion 33 of the first support member 31 extends in the same direction as the bisector 107 of the cutout corner portion 49 of the cutout portion 41 in plan view. The second support member 32 is also temporarily fixed to the other cutout portion 41 of the second plate 40 by a method similar to the temporary fixing of the first support member 31.

Examples of a method of the temporary fixing include a method using a jig and a method using welding. For example, only the end portion of the first support member 31 is welded to the second plate 40 by welding. Further, only the end portion of the second support member 32 is welded to the second plate 40 by welding.

In the first welding step, the support portion 30 and the first plate 20 are welded to each other in a state in which the support portion 30 is temporarily fixed to the second plate 40. The first cutout region 42A is located along the first boundary region 36A of the first boundary line 36 by the temporary fixing between the second plate 40 and the support portion 30 (the first support member 31 and the second support member 32) in the temporary fixing step described above. In this state, the first support member 31 is disposed on the first plate 20 such that the end portion of the first support member 31 and the end portion of second support member 32 are located near the positioning portions 22, respectively, of the first plate 20. Thereafter, the portion of the support portion 30 including the first boundary region 36A is welded to the first plate 20 such that the welding rod 140A is aligned along the first cutout region 42A.

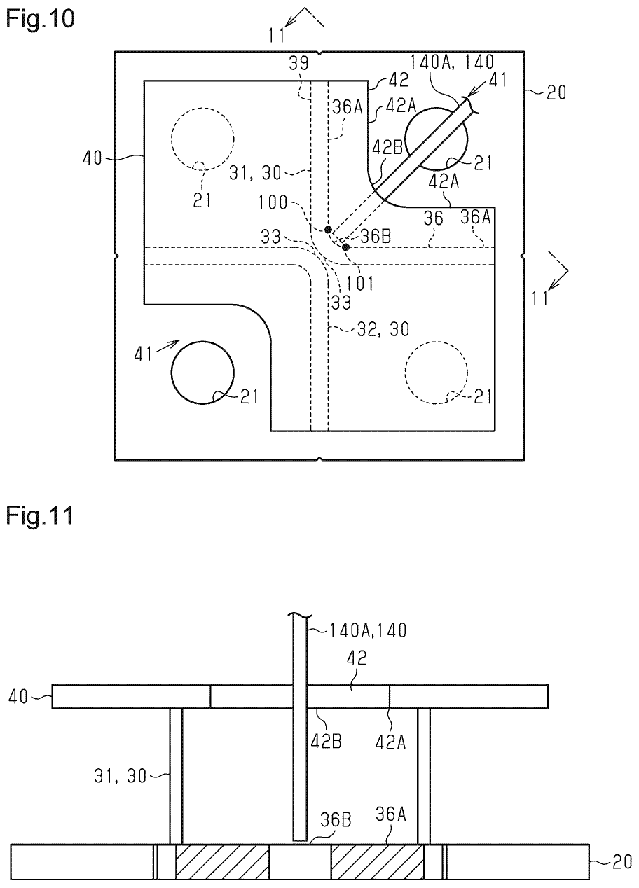

As illustrated in FIGS. 8 and 9, in the welding between the first support member 31 and the upper surface of the first plate 20, first, the welding is performed in a state in which a tip of the welding rod 140A is directed to the first boundary region 36A along the one first cutout region 42A while the welding rod 140A is aligned along one first cutout region 42A of the two first cutout regions 42A. Thereafter, when the welding rod 140A reaches the second cutout region 42B (see FIG. 10) of the cutout edge 42, the welding is performed with the welding rod 140A being aligned along the second cutout region 42B.

As illustrated in FIGS. 10 and 11, welding is performed in a state in which the tip of the welding rod 140A is directed to the first arc portion 36B while the welding rod 140A is aligned along the second cutout region 42B. Thereafter, when the welding rod 140A advances to the other first cutout region 42A, the welding rod 140A is aligned along the other first cutout region 42A. At this time, welding is performed in a state in which the tip of the welding rod 140A is directed to the first boundary region 36A along the other first cutout region 42A.

In the welding between the first support member 31 and the upper surface of the first plate 20, after the welding of a portion of the first support member 31 including the first boundary line 36 is completed, the remaining portion is welded. Specifically, the upper surface of the first plate 20 and the portion of the first support member 31 including the third boundary line 39 are welded to each other.

After the welding between the first support member 31 and the upper surface of the first plate 20 is completed, the welding between the second support member 32 and the upper surface of the first plate 20 is performed by the same procedure. The support portion 30 is welded to the first plate 20 by the above procedure.

The steps of the procedure of welding the first support member 31 and the second support member 32 to the upper surface of the first plate 20 may be changed. For example, after welding the second support member 32 to the upper surface of the first plate 20, the first support member 31 may be welded to the upper surface of the first plate 20. Alternatively, after welding the corner portion 33 including the first arc portion 36B to the upper surface of the first plate 20 first, the first boundary region 36A may be welded to the upper surface of the first plate 20. In the welding between the support portion 30 and the upper surface of the first plate 20, after completing the welding of a portion excluding the first boundary line 36 portion, the first boundary line 36 portion may be welded.

In the second welding step, the support portion 30 and the second plate 40 are welded to each other. Specifically, the first support member 31 and the lower surface of the second plate 40 are welded to each other. The second support member 32 and the lower surface of the second plate 40 are welded to each other.

In the welding between the support portion 30 and the lower surface of the second plate 40, after the welding of the second boundary line 131 portion is completed, the remaining portion is welded. Specifically, the lower surface of the second plate 40 and a portion of the first support member 31 including the fourth boundary line 139 are welded to each other. The lower surface of the second plate 40 and a portion of the second support member 32 including the fourth boundary line 139 are welded to each other.

The order of the steps in the procedure of welding the support portion 30 to the lower surface of the second plate 40 may be changed. For example, after welding the corner portion 33 including the second arc portion 131B to the lower surface of the second plate 40 first, the second boundary region 131A may be welded to the lower surface of the second plate 40. In the welding between the support portion 30 and the lower surface of the second plate 40, after completing the welding of a portion excluding the second boundary line 131 portion, the second boundary line 131 portion may be welded.

In the third welding step, the coupling portion 50 is welded to the second plate 40. The column fixing metal member 10 is manufactured by the above manufacturing method.

### Building

As illustrated in FIG. 7, the building 1 includes the foundation portion 3, the column 2, and the column fixing metal member 10. The building 1 may include a horizontal member and a gradient member forming a roof. The foundation portion 3 includes a foundation. The foundation portion 3 may include the foundation and a sill provided on the foundation. The sill is made of wood. In the present embodiment, the foundation portion 3 does not include the sill but includes a foundation made of reinforced concrete.

The foundation portion 3 includes the anchor bolts 120 made of iron. The anchor bolts 120 are installed on the foundation portion 3 such that head portions of the anchor bolts 120 protrude from an upper surface 3A of the foundation portion 3. In the foundation portion 3, the anchor bolts 120 are provided at predetermined positions. Two anchor bolts 120 are provided at predetermined positions, respectively, of the foundation portion 3. The two anchor bolts 120 provided at the predetermined positions, respectively, are disposed at a predetermined interval. In one example, the two anchor bolts 120 are disposed such that, a line passing through the two anchor bolts 120 intersects the side surface 3B of the foundation portion 3 at an angle of 45 degrees in plan view (see FIG. 7).

The column fixing metal member 10 is fixed to the foundation portion 3 by the nuts 122 via the two anchor bolts 120, respectively. Specifically, the first plate 20 of the column fixing metal member 10 is fixed to the foundation portion 3 by the nut 122 via the anchor bolt 120.

The column 2 is coupled to the coupling portion 50 of the column fixing metal member 10 by the drift pins 51. The column 2 of the following configuration are used as the column. A column in which a longitudinal width and a lateral width of the column 2 in the cross section are larger than a longitudinal width and a lateral width of the second plate 40 in plan view is used. An outer periphery 2A of the column 2 is located outside the second plate 40.

The column 2 and the coupling holes 52 of the column fixing metal member 10 preferably have the following relationship. Among the multiple coupling holes 52 in the column fixing metal member 10, the coupling hole 52 closest to the side surface of the column 2 in the lateral direction LA is located at a predetermined interval from the side surface of the column 2. For example, the center of the first coupling hole 52A is located at a position spaced apart by an interval of 16 mm or more from the side surface of the column 2.

The horizontal member is coupled to the columns 2 so as to extend over multiple columns 2. An outer wall, an inner wall, and the like are formed by the columns 2 and the horizontal members. The gradient members are coupled to the horizontal members or the columns 2. A roof is formed by the gradient members.

The operation of the present embodiment will be described.

The second plate 40 in the column fixing metal member 10 is provided with the two cutout portions 41. Thus, the anchor bolt 120 can be readily inserted into the insertion hole 21 of the first plate 20 as compared with the case in which the hole is provided in the second plate 40. In addition, it is easy to check the position of the anchor bolt 120 in the insertion hole 21.

The support portion 30 of the column fixing metal member 10 includes the first end surface 34 in contact with the upper surface of the first plate 20 and the side surface 35 intersecting the first end surface 34. The support portion 30 includes the first boundary line 36 at the boundary between the first end surface 34 and the side surface 35. The first boundary line 36 includes the first boundary region 36A. The second plate 40 of the column fixing metal member 10 includes the cutout portion 41 including the cutout edge 42. The cutout edge 42 includes the first cutout region 42A. The first cutout region 42A is configured to extend along the first boundary region 36A in plan view. The portion of the support portion 30 including the first boundary region 36A is fixed to the first plate 20 by welding.

Conventionally, the column fixing metal member is not designed with consideration for smoothly welding of the support portion to the first plate. In this regard, according to the present embodiment, the second plate 40 is cut out such that the first cutout region 42A extends along the first boundary region 36A in plan view as described above. As a result, the first boundary region 36A is readily and smoothly welded to the first plate 20 by aligning the welding rod 140A of the welding tool 140 along the first cutout region 42A. Thus, the support portion 30 is appropriately welded to the first plate 20. As a result, in the manufacture of the column fixing metal member 10, the column fixing metal members 10 having a low strength are reduced. For example, the column fixing metal members 10 in which the welded portions are deviated from the predetermined positions, respectively, are reduced. Thus, according to such a structure of the column fixing metal member 10, the variation of the individual strength of the column fixing metal members 10 is reduced, and as a result, an average strength of the column fixing metal members 10 is increased.

Advantages of the present embodiment will be described.
(1) The column fixing metal member 10 includes the first plate 20, the support portion 30, and the second plate 40. The support portion 30 includes the first boundary line 36. The first boundary line 36 includes the first boundary region 36A. The cutout edge 42 of the cutout portion 41 in the second plate 40 includes the first cutout region 42A. The first cutout region 42A is configured to extend along the first boundary region 36A of the support portion 30 in plan view. The portion of the support portion 30 including the first boundary region 36A is fixed to the first plate 20 by welding.

According to this configuration, when the portion of the support portion 30 including the first boundary region 36A is welded to the first plate 20, the portion including the first boundary region 36A is smoothly welded to the first plate 20 by aligning the welding rod 140A of the welding tool 140 along the first cutout region 42A. As described above, the column fixing metal member 10 has a structure that can be smoothly welded, and thus the number of column fixing metal members 10 each having a low strength at the welded portion can be reduced. Thus, when the strength of the column fixing metal members 10 is averaged, the average strength of the column fixing metal members 10 is increased. As described above, it is possible to provide the column fixing metal members 10 having a high average strength. In the manufacturing, the yield of the column fixing metal member 10 is increased.
(2) The cutout edge 42 of the cutout portion 41 is configured to extend along the first boundary line 36 of the support portion 30 in plan view. That is, the entire cutout edge 42 of the cutout portion 41 extends along the first boundary line 36 of the support portion 30 in plan view. According to this configuration, the support portion 30 and the upper surface of the first plate 20 are smoothly welded to each other by aligning the welding rod 140A of the welding tool 140 along the cutout edge 42. Thus, it is possible to provide a column fixing metal member 10 having a high strength.
(3) The support portion 30 includes the first support member 31 and the second support member 32. The first support member 31 and the second support member 32 are configured to include the corner portions 33, respectively. The support portion 30 is disposed on the first plate 20 such that the convex portion at the corner portion 33 of the first support member 31 faces the convex portion at the corner portion 33 of the second support member 32. According to this configuration, the second plate 40 can be supported by the first support member 31 and the second support member 32. According to the structure in which the second plate 40 is supported by the first support member 31 and the second support member 32, a manufacturing process of the column fixing metal member 10 is simplified as compared with a structure in which the second plate 40 is supported by four support members each having a plate shape. Thus, according to this structure, the column fixing metal member 10 can be readily manufactured.
(4) The bisector 106 of the corner portion 33 of the first support member 31 extends in the same direction as the bisector 107 of the cutout corner portion 49 of the cutout portion 41 in plan view. According to this configuration, the tip of the welding rod 140A of the welding tool 140 can be readily aligned with the corner portion 33 of the support portion 30 by aligning the welding rod 140A of the welding tool 140 along the cutout corner portion 49. As a result, the corner portion 33 is appropriately welded to the first plate 20. Thus, the bonding strength between the support portion 30 and the first plate 20 is improved.
(5) The outer periphery 47 of the second plate 40 is located inside the outer periphery 27 of the first plate 20 in plan view. According to this configuration, it is easy to check the state of the first plate 20 in a state in which the column fixing metal member 10 is placed on the foundation portion 3. For example, it is easy to check whether one side of the outer periphery 27 of first plate 20 and the side surface 3B of the foundation portion 3 are parallel to each other.
(6) The building 1 includes the foundation portion 3, the column 2, and the column fixing metal member 10 according to any one of above-described (1) to (5). The first plate 20 of the column fixing metal member 10 is fixed to the foundation portion 3, and the column 2 is coupled to the coupling portion 50 of the column fixing metal member 10.

According to this configuration, in the building 1, the coupling strength of the column 2 with respect to the foundation portion 3 is improved, and thus the earthquake resistance of the building 1 is improved.
(7) The outer periphery 2A of the column 2 is located outside the second plate 40 of the column fixing metal member 10 in plan view of the building 1. When the outer periphery 2A of the column 2 is located inside the second plate 40, water condensed on the column 2 may be accumulated in the second plate 40. In this respect, according to the above configuration, the condensed water readily drips downward from a lower end of the column 2 without being hindered by the second plate 40. As a result, accumulation of water in the second plate 40 is suppressed, and thus aged deterioration of the column 2 due to water is suppressed.
(8) The method for manufacturing the column fixing metal member 10 includes the temporary fixing step of temporarily fixing the second plate 40 and the support portion 30 to each other, the first welding step of welding the support portion 30 and the first plate 20 to each other in a state in which the support portion 30 is temporarily fixed to the second plate 40, the second welding step of welding the second plate 40 and the support portion 30 to each other, and the third welding step of welding the coupling portion 50 and the second plate 40 to each other. The first boundary line 36 includes the first boundary region 36A. The second plate 40 includes the cutout portion 41 including the cutout edge 42. The cutout edge 42 of the second plate 40 includes the first cutout region 42A. In the temporary fixing step, the second plate 40 is temporarily fixed to the support portion 30 in a state in which the second plate 40 is disposed on the support portion 30 such that the first cutout region 42A of the cutout portion 41 extends along the first boundary region 36A of the first boundary line 36. In the first welding step, the portion of the support portion 30 including the first boundary region 36A is welded to the first plate 20 such that the welding rod 140A of the welding tool 140 is aligned along the first cutout region 42A. According to this configuration, welding is performed while the welding rod 140A of the welding tool 140 is aligned along the first cutout region 42A, and thus the portion including the first boundary region 36A and the first plate 20 are appropriately welded to each other.

### Second Embodiment

A method for manufacturing the column fixing metal member 10 according to a second embodiment will be described. In the present embodiment, the configuration common to the first embodiment is denoted by the same reference numeral as that of the first embodiment, and the description of the overlapping configuration is omitted.

The method for manufacturing the column fixing metal member 10 of the present embodiment includes the first welding step, the second welding step, and the third welding step. In the present embodiment, welding of the temporary fixing of the first embodiment need not be performed.

In the first welding step, the second plate 40 is welded to the support portion 30. Specifically, in the first welding step, the second plate 40 is welded to the support portion 30 in a state in which the second plate 40 is disposed on the support portion 30 such that the first cutout region 42A of the cutout portion 41 extends along the first boundary region 36A of the first boundary line 36.

In the second welding step, the support portion 30 is welded to the first plate 20 fixed to the foundation portion 3. In the third welding step, the coupling portion 50 coupled to the column 2 is welded to the second plate 40. The welding procedure is similar to the procedure of the third welding step of the first embodiment. The column fixing metal member 10 is manufactured by the above manufacturing method.

According to the configuration of the present embodiment, the support portion 30 can be welded to the first plate 20 in a state in which the first cutout region 42A extends along the first boundary region 36A in plan view. At this time, the portion including the first boundary region 36A can be welded to the first plate 20 such that the welding rod 140A of the welding tool 140 is aligned along the first cutout region 42A. Thus, the portion including the first boundary region 36A and the first plate 20 can be appropriately welded to each other.

### Third Embodiment

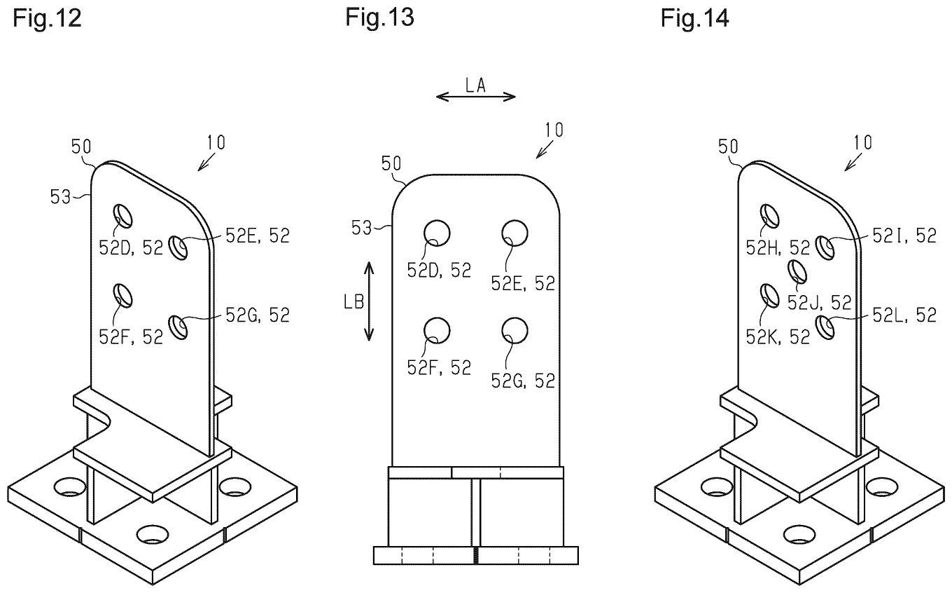

A column fixing metal member 10 according to a third embodiment will be described with reference to FIGS. 12 and 13. In the present embodiment, the configuration common to the first embodiment is denoted by the same reference numeral as that of the first embodiment, and the description of the overlapping configuration is omitted.

As illustrated in FIGS. 12 and 13, the coupling portion 50 of the present embodiment is provided with a fourth coupling hole 52D, a fifth coupling hole 52E, a sixth coupling hole 52F, and a seventh coupling hole 52G.

In a front view of the coupling portion 50, the coupling holes 52 are provided at predetermined positions, respectively, of the coupling portion 50. For example, in the present embodiment, the coupling holes 52 adjacent to each other in the lateral direction LA are provided at a predetermined interval. Specifically, the fourth coupling hole 52D and the fifth coupling hole 52E adjacent to each other along the lateral direction LA are disposed so as to be at an interval of 35 mm or more from a center of the fourth coupling hole 52D to a center of the fifth coupling hole 52E. In addition, the sixth coupling hole 52F and the seventh coupling hole 52G adjacent to each other along the lateral direction LA are disposed so as to be at an interval of 35 mm or more from a center of the sixth coupling hole 52F to a center of the seventh coupling hole 52G.

The coupling holes 52 adjacent to each other in the longitudinal direction LB are provided in the coupling portion 50 at a predetermined interval in a front view. Specifically, the fourth coupling hole 52D and the sixth coupling hole 52F adjacent to each other along the longitudinal direction LB are disposed so as to be at an interval of 45 mm or more from the center of the fourth coupling hole 52D to the center of the sixth coupling hole 52F. The fifth coupling hole 52E and the seventh coupling hole 52G adjacent to each other along the longitudinal direction LB are disposed so as to be at an interval of 45 mm or more from the center of the fifth coupling hole 52E to the center of the seventh coupling hole 52G.

Among the coupling holes 52, the coupling hole 52 closest to the coupling end surface 53 in the lateral direction LA is provided in the coupling portion 50 at a predetermined interval from the coupling end surface 53 in a front view. For example, in the present embodiment, the center of the fourth coupling hole 52D is located at a position spaced apart by an interval of 20 mm or more from the coupling end surface 53 in the lateral direction LA.

According to the configuration of the present embodiment, the column 2 and the coupling portion 50 can be coupled to each other by the four drift pins 51. In addition, the column fixing metal member 10 of the present embodiment has an advantage similar to (1) of the first embodiment.

### Fourth Embodiment

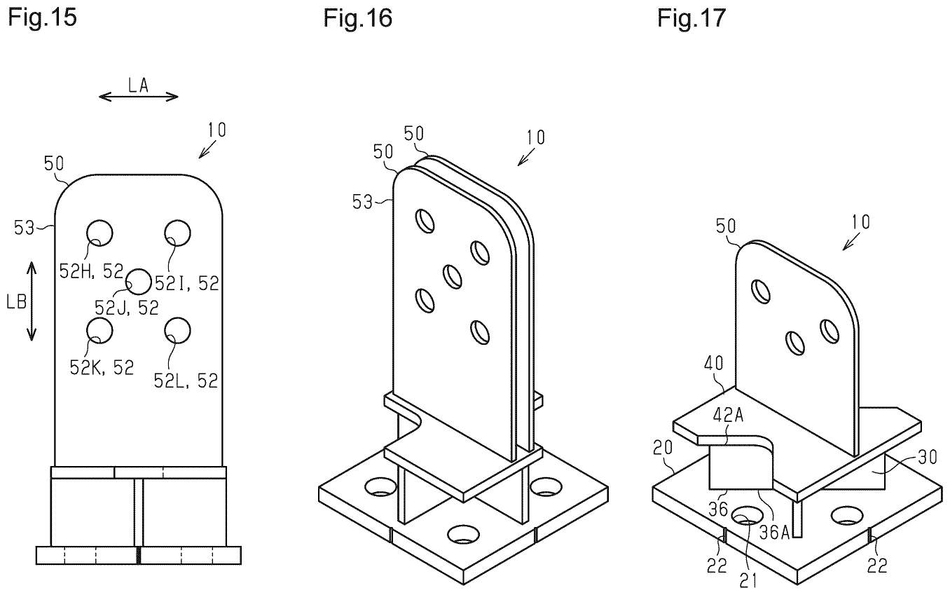

The column fixing metal member 10 according to a fourth embodiment will be described with reference to FIGS. 14 and 15. In the present embodiment, the configuration common to the first embodiment is denoted by the same reference numeral as that of the first embodiment, and the description of the overlapping configuration is omitted.

As illustrated in FIGS. 14 and 15, the coupling portion 50 of the present embodiment is provided with an eighth coupling hole 52H, a ninth coupling hole 52I, a tenth coupling hole 52J, an eleventh coupling hole 52K, and a twelfth coupling hole 52L.

In a front view of the coupling portion 50, the coupling holes 52 are provided at predetermined positions, respectively, of the coupling portion 50. For example, in the present embodiment, the coupling holes 52 adjacent to each other in the lateral direction LA are provided at a predetermined interval. Specifically, the eighth coupling hole 52H and the ninth coupling hole 52I adjacent to each other along the lateral direction LA are disposed so as to be at an interval of 35 mm or more from a center of the eighth coupling hole 52H to a center of the ninth coupling hole 52I. Further, the eleventh coupling hole 52K and the twelfth coupling hole 52L adjacent to each other along the lateral direction LA are disposed so as to be at an interval o 35 mm or more from a center of the eleventh coupling hole 52K to a center of the twelfth coupling hole 52L.

The coupling holes 52 adjacent to each other in the longitudinal direction LB are provided in the coupling portion 50 at a predetermined interval in a front view. Specifically, the eighth coupling hole 52H and the eleventh coupling hole 52K adjacent to each other along the longitudinal direction LB are disposed so as to be at an interval of 45 mm or more from the center of the eighth coupling hole 52H to the center of the eleventh coupling hole 52K. In addition, the ninth coupling hole 52I and the twelfth coupling hole 52L adjacent to each other along the longitudinal direction LB are disposed so as to be at an interval of 45 mm or more from the center of the ninth coupling hole 52I to the center of the twelfth coupling hole 52L.

The tenth coupling hole 52J is provided at a predetermined interval from the other coupling holes 52. In the present embodiment, the tenth coupling hole 52J is located to be at an equal interval from a center of the tenth coupling hole 52J to the centers of the other coupling holes 52, respectively.

Among the coupling holes 52, the coupling hole 52 closest to the coupling end surface 53 in the lateral direction LA is provided in the coupling portion 50 at a predetermined interval from the coupling end surface 53 in a front view. For example, in the present embodiment, the center of the eighth coupling hole 52H is located at a position spaced apart by an interval of 20 mm or more from the coupling end surface 53 in the lateral direction LA.

According to the configuration of the present embodiment, the column 2 and the coupling portion 50 can be coupled to each other by the five drift pins 51. In addition, the column fixing metal member 10 of the present embodiment has an advantage similar to (1) of the first embodiment.

### Fifth Embodiment

The column fixing metal member 10 according to a fifth embodiment will be described with reference to FIG. 16. In the present embodiment, the configuration common to the first embodiment is denoted by the same reference numeral as that of the first embodiment, and the description of the overlapping configuration is omitted.

The second plate 40 of the present embodiment is provided with the coupling portions 50 extending upward from the second plate 40 and coupled to the column 2. In the present embodiment, two coupling portions 50 are provided. One coupling portion 50 is provided on the second plate 40 in parallel with the other coupling portion 50.

According to the configuration of the present embodiment, the column fixing metal member 10 is coupled to the column 2 by the two coupling portions 50. Thus, the column 2 and the coupling portion 50 are firmly coupled to each other.

### Modifications

Each of the above embodiments is an example of the column fixing metal member 10, the method for manufacturing the column fixing metal member 10, and possible forms of the building 1, and is not intended to limit the form. The column fixing metal member 10, the method for manufacturing the column fixing metal member 10, and the building 1 can take forms different from the forms exemplified in the above embodiments, respectively. One example thereof is a form in which a part of the configuration of the embodiment is replaced, changed, or omitted, or a form in which a new configuration is added to the embodiment. One example of a modification of the embodiment will be described below.
(1) As illustrated in FIG. 17, the first plate 20 may be provided with the insertion hole 21 through which the anchor bolt 120 is inserted near the positioning portion 22. In this case, the end portion of the support portion 30 is provided on the first plate 20 so as to extend toward the corner portion of the first plate 20. The first cutout region 42A is cut out to extend along the first boundary region 36A in plan view.

According to this configuration, the first cutout region 42A is cut out to extend along the first boundary region 36A in plan view. As a result, when the portion including the first boundary region 36A of the support portion 30 is welded to the first plate 20, the portion including the first boundary region 36A is smoothly welded to the first plate 20 by aligning the welding rod 140A of the welding tool 140 along the first cutout region 42A. As described above, the column fixing metal member 10 has a structure that can be smoothly welded, and thus the number of column fixing metal members 10 each having a low strength at the welded portion can be reduced. Thus, when the strengths of the column fixing metal members 10 are averaged, the average strength of the column fixing metal members 10 is increased. As described above, it is possible to provide the column fixing metal member 10 having a high strength as the average strength. In the manufacture, the yield of the column fixing metal member 10 is increased.
(2) The corner portion 33 of the first support member 31 or the corner portion 33 of the second support member 32 may be configured as follows. For example, the first arc portion 36B is configured to extend along a concentric circle concentric with a second circle including the second cutout region 42B in plan view of the column fixing metal member 10. In addition, the corner portion 33 of the first support member 31 or the corner portion 33 of the second support member 32 may be configured as follows. For example, the first arc portion 36B is configured such that a first circle including the first arc portion 36B is a circle smaller than the second circle including the second cutout region 42B. The first arc portion 36B is an arc having a radius smaller than a radius of the second circle including the second cutout region 42B.

According to this configuration, the tip of the welding rod 140A of the welding tool 140 can be readily aligned with the first arc portion 36B of the support portion 30 by aligning the welding rod 140A of the welding tool 140 along the second cutout region 42B. As a result, the corner portion 33 is appropriately welded to the first plate 20. Thus, the bonding strength between the support portion 30 and the first plate 20 is improved.
(3) A cutout region similar to the first cutout region 42A or the second cutout region 42B may be provided in the projected corner portion 48 of the second plate 40. According to this configuration, advantages similar to the first embodiment can be obtained. Specifically, the portion including the third boundary line 39 of each of the first support member 31 and the second support member 32 can be smoothly welded to the first plate 20.
(4) The coupling end surface 53 of the coupling portion 50 may be located outside the outer periphery 47 of the second plate 40 in plan view of the column fixing metal member 10. According to this configuration, when the column 2 and the coupling portion 50 are coupled to each other, the size of the area where the column 2 and the coupling portion 50 are coupled to each other is increased. Thus, the coupling strength between the column 2 and the coupling portion 50 is increased.
(5) The first arc portion 36B may be configured to be a curve in plan view. The second cutout region 42B is configured to extend along the first arc portion 36B in plan view. According to this configuration, the portion of the first arc portion 36B of the support portion 30 is smoothly welded to the upper surface of the first plate 20 by aligning the welding rod 140A of the welding tool 140 along the second cutout region 42B.
(6) In the method for manufacturing the column fixing metal member 10 of the first embodiment, the second welding step may be performed after the temporary fixing step, and the first welding step may be performed after the second welding step. In the temporary fixing step, only the end portion of the first support member 31 is temporarily fixed to the second plate 40. In addition, only the end portion of the second support member 32 is temporarily fixed to the second plate 40. In the second welding step, the support portion 30 in which only the end portion is temporarily fixed to the second plate 40 by the temporary fixing step and the second plate 40 are welded to each other.

According to the configuration, the support portion 30 can be welded to the first plate 20 in a state in which the first cutout region 42A extends along the first boundary region 36A in plan view. At this time, the portion including the first boundary region 36A can be welded to the first plate 20 such that the welding rod 140A of the welding tool 140 is aligned along the first cutout region 42A. Thus, the portion including the first boundary region 36A and the first plate 20 can be appropriately welded to each other.

### REFERENCE SIGNS LIST

1 Building
2 Column
2A Outer Periphery of Column 2
3 Foundation Portion
10 Column Fixing Metal Member
20 First Plate
27 Outer Periphery of First Plate 20
30 Support Portion
31 First Support Member
32 Second Support Member
33 Corner Portion
34 First End Surface
35 Side Surface
36 First Boundary Line
36A First Boundary Region
36B First Arc Portion
40 Second Plate
41 Cutout portion
42 Cutout edge
42A First Cutout region
42B Second Cutout region
47 Outer Periphery of Second Plate 40
49 Cutout corner Portion
50 Coupling Portion
106 Bisector of Corner Portion 33 of First Support Member 31
107 Bisector of Corner Portion 33 of Second Support Member 32
140 Welding Tool
140A Welding Rod

1. A column fixing metal member configured to fix a column to a foundation portion, the column fixing metal member comprising:
a first plate configured to be fixed to the foundation portion;
a support portion provided on the first plate;
a second plate provided on an upper portion of the support portion; and
a coupling portion extending upward from the second plate and configured to be coupled to the column, wherein
the support portion includes a first end surface in contact with an upper surface of the first plate, a side surface intersecting the first end surface, and a first boundary line that is a boundary between the first end surface and the side surface,
the first boundary line includes a first boundary region,
the second plate includes a cutout portion including a cutout edge,
the cutout edge of the cutout portion includes a first cutout region,
the first cutout region of the cutout portion extends along the first boundary region of the support portion, in plan view, and
a portion of the support portion including the first boundary region is fixed to the first plate by welding.

2. The column fixing metal member according to claim 1, wherein the cutout edge of the cutout portion extends along the first boundary line of the support portion, in plan view.

3. The column fixing metal member according to claim 1, wherein
the support portion includes a first support member and a second support member,
the first support member and the second support member include corner portions, respectively, and
the first support member and the second support member are disposed on the first plate such that a convex portion at the corner portion of the first support member faces a convex portion at the corner portion of the second support member.

4. The column fixing metal member according to claim 3, wherein
the cutout portion includes a cutout corner portion, and
a bisector of the corner portion of the first support member extends in a same direction as a bisector of the cutout corner portion of the cutout portion, in plan view.

5. The column fixing metal member according to claim 4, wherein
the first boundary line includes a first arc portion forming the corner portion,
the cutout portion includes a second cutout region having an arc shape forming the cutout corner portion, and
the first arc portion either
extends along a concentric circle concentric with a second circle including the second cutout region, in plan view, or
is an arc having a radius smaller than a radius of the second circle including the second cutout region.

6. The column fixing metal member according to claim 1, wherein an outer periphery of the second plate is located inside an outer periphery of the first plate, in plan view.

7. A building comprising:
a foundation portion;
a column; and
the column fixing metal member according to claim 1, wherein the first plate of the column fixing metal member is fixed to the foundation portion, and the column is coupled to the coupling portion of the column fixing metal member.

8. The building according to claim 7, wherein an outer periphery of the column is located outside the second plate of the column fixing metal member in plan view.

9. A method for manufacturing a column fixing metal member, the column fixing metal member including a first plate, a support portion, a second plate, and a coupling portion configured to be coupled to a column, the method comprising:
temporarily fixing the second plate and the support portion to each other;
firstly welding the support portion and the first plate to each other in a state in which the support portion is temporarily fixed to the second plate;
secondly welding the second plate and the support portion to each other; and
thirdly welding the coupling portion to the second plate; wherein the support portion includes:
a first end surface in contact with an upper surface of the first plate;
a side surface intersecting the first end surface; and
a first boundary line that is a boundary between the first end surface and the side surface,
the first boundary line includes a first boundary region,
the second plate includes a cutout portion including a cutout edge,
the cutout edge of the second plate includes a first cutout region,
in the temporary fixing the second plate and the support portion to each other. the second plate is temporarily fixed to the support portion in a state in which the second plate is disposed on the support portion such that the first cutout region of the cutout portion extends along the first boundary region of the first boundary line, and
in the firstly welding the support portion and the first plate to each other, a portion of the support portion including the first boundary region is welded to the first plate such that a welding rod of a welding tool is aligned along the first cutout region.

10. A method for manufacturing a column fixing metal member, the column fixing metal member including a first plate, a support portion, a second plate, and a coupling portion coupled to a column, the method comprising:
firstly welding the support portion to the second plate;
secondly welding the first plate to the support portion; and
thirdly welding the coupling portion to the second plate; wherein the support portion includes:
a first end surface in contact with an upper surface of the first plate;
a side surface intersecting the first end surface; and
a first boundary line that is a boundary between the first end surface and the side surface,
the first boundary line includes a first boundary region,
the second plate includes a cutout portion including a cutout edge,
the cutout edge of the second plate includes a first cutout region,
in the firstly welding the support portion to the second plate, the second plate is welded to the support portion in a state in which the second plate is disposed on the support portion such that the first cutout region of the cutout portion extends along the first boundary region of the first boundary line, and
in the secondly welding the first plate to the support portion, a portion of the support portion including the first boundary region is welded to the first plate such that a welding rod of a welding tool is aligned along the first cutout region.
